(19) United States
(12) Patent Application Publication
(10) Pub. No.: US 2009/0216362 A1
(43) Pub. Date: Aug. 27, 2009

(54) Calibration of a machine tool

(75) Inventor: Steven Weeks, Bristol (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 12/314,766

(22) Filed: Dec. 16, 2008

(30) Foreign Application Priority Data
Feb. 21, 2008 (GB) 0803084.3
Nov. 24, 2008 (GB) 0821399.3

(51) Int. Cl. G05B 19/19; G06F 19/00

(52) U.S. Cl. 700/162; 700/192; 700/160

(57) ABSTRACT

Calibration apparatus comprising a positional calibration means, and a machine tool assembly chuck configured to, in use, locate a machine tool assembly comprising a machine tool configured to be adjustably mounted on a machine tool mount. The positional calibration means and chuck are mounted on a common base relative to one another. The positional calibration means comprises a calibration headstock provided with a positional feature engagement means for cooperative engagement with a machine tool location feature provided on the machine tool. When the machine tool is adjusted on the machine tool mount relative to the positional calibration means, cooperative engagement of the positional feature engagement means and the machine tool location feature indicates the machine tool is aligned along a predetermined machine tool calibration axis.

The invention relates to calibration apparatus for positional calibration of machine tool.

Further the invention relates to a method of calibrating a machine tool.

Automated machines such as Electro Discharge Machines (EDM) and electrode welding machines consist of a machine tool fitted to a machine tool mount, where the machine tool defines where an operation on a work piece will occur. In such machines the machine tool may take the form of a nozzle guide for an electrode, where the end of the nozzle guide will define where the electrode makes contact with the work piece. It is thus essential that the nozzle guide be aligned correctly relative to its mount, and hence its parent machine.

For use with a given parent machine, the desired position of the end of the machine tool relative to its mount is determined. When a machine tool is fitted to the machine, the machine tool must be calibrated such that that the position of its working end coincides with the desired position on a work piece. Conventionally this is achieved by fitting a mounted machine tool in a chuck on a Co-ordinate Measuring Machine (CMM). A program for each type of machine tool must be written to instruct the CMM where to take measurements, for example, the working end where the electrode is exposed, and the CMM must be set up correctly. The measurements taken are then be interpreted and the machine tool adjusted on its mount so that the machine tool is correctly aligned relative to its mount. The machine tool is then measured again on the CMM to ensure that the correct adjustment was made.

This calibration process has the disadvantage that it requires a CMM, which are expensive, and requires a skilled user to operate it correctly. Additionally the process takes a significant amount of time to execute. After calibration the machine tool will need transporting to the correct machine, which provides opportunities for mishandling of the machine tool and disturbing its calibration.

Hence a calibration apparatus which does not rely on measurement of the machine tool, which is of simple construction and can be easily operated is highly desirable.

According to a first aspect of the present invention, there is provided a calibration apparatus for positional calibration of a machine tool assembly comprising a positional calibration means, and a machine tool assembly chuck configured to, in use, locate a machine tool assembly which comprising a machine tool configured to be adjustably mounted on a machine tool mount, the positional calibration means and chuck mounted on a common base relative to one another, wherein the positional calibration means comprises a calibration headstock provided with a positional feature engagement means for cooperative engagement with a machine tool location feature provided on the machine tool, such that when the machine tool is adjusted on the machine tool mount relative to the positional calibration means, cooperative engagement of the positional feature engagement means and the machine tool location feature indicates the machine tool is aligned along a predetermined machine tool calibration axis.

According to a second aspect of the present invention, there is provided a method of calibrating a machine tool assembly using a calibration apparatus as claimed in any one of the preceding claims, wherein the machine tool assembly is mounted on the chuck, and the machine tool is adjusted in a substantially perpendicular direction to the calibration axis so that the positional feature engagement means on the calibration headstock may be cooperatively engaged with the machine tool location feature, thereby aligning the machine tool with the calibration axis.

Thus the invention provides a calibration device and operation thereof, which relies on an alignment of a machine tool with a previously calibrated positional calibration means, so that, provided the location feature on the machine tool is aligned with the positional calibration means on the calibration apparatus, the machine tool is correctly aligned relative to its mount. Hence when the machine tool assembly is fitted to its parent machine for operation, the machine tool will be aligned as per the operational needs of the parent machine. This obviates the need for a complex measurement process, for example employing a CMM, to ensure correct alignment of the machine tool.

Preferably the calibration apparatus as comprises a machine tool assembly which comprises a machine tool adjustably mounted on a machine tool mount. Preferably the machine tool is adjustable in a direction substantially perpendicular to the calibration axis. The machine tool may be provided with a machine tool location feature.

The invention will now be described, by way of example only, with reference to the accompanying drawings in which:

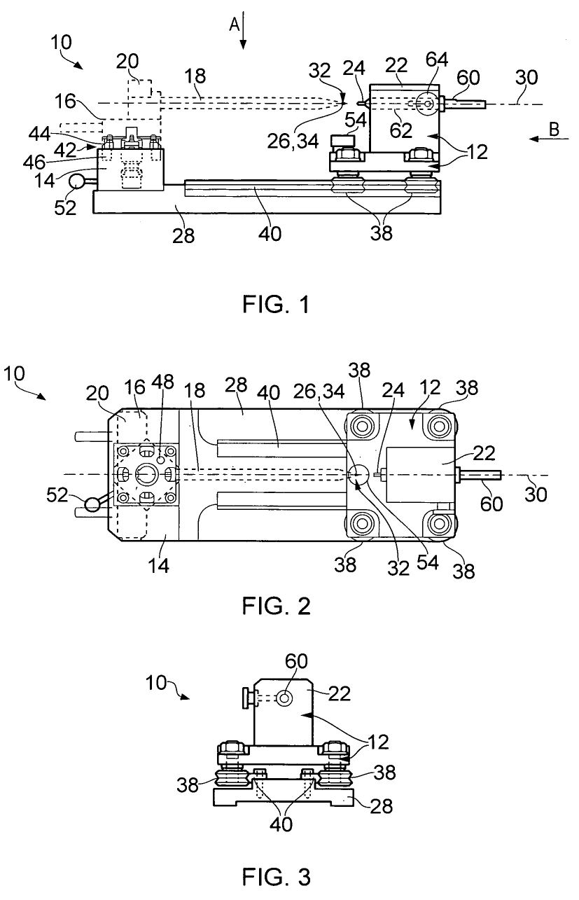

FIG. 1 shows a side view of a calibration apparatus according to the present invention;

FIG. 2 shows a plan view of the calibration apparatus, as seen from the direction of arrow “A” in FIG. 1;

FIG. 3 shows a side view of the calibration apparatus, as seen from the direction of arrow “B” in FIG. 1;

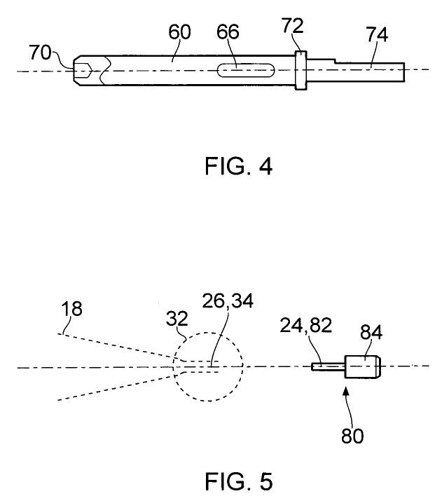

FIG. 4 shows an enlarged view of a location member fitted to the apparatus in FIGS. 1, 2 and 3; and

FIG. 5 shows an enlarged view of a pin like member configured to fit inside the machine tool location member.

A side view of a calibration apparatus 10 according to the present invention is shown in FIG. 1. Plan and end views, as seen from the direction of arrows “A” and “B” in FIG. 1, are presented in FIG. 2 and FIG. 3 respectively. The calibration apparatus 10 comprises a positional calibration means 12 and a machine tool assembly chuck 14 for locating a machine tool assembly 16 (shown in a dotted line). The machine tool assembly 16 consists of a machine tool 18 adjustably mounted on a machine tool mount 20. The positional calibration means 12 consists of a calibration headstock 22 provided with a positional feature engagement means 24 for positive (that is to say, “cooperative”) engagement with a machine tool location feature 26 provided on the machine tool 18. The positional calibration means 12 and chuck 14 are mounted on a common base 28 relative to one another. The positional feature engagement means 24 is aligned with a predetermined machine tool calibration axis 30. That is to say, the axis 30 which passes through the positional feature engagement means 24 defines the desired calibration axis 30 of the machine tool 18. The location of the positional feature engagement means 24, and hence the axis 30, defines the required position of the working end 32 of the machine tool 18 relative to the machine tool assembly mount 20, and corresponds to the required position of the working end 32 relative to a chuck on the parent machine (not shown) to which the machine tool 18 will be mounted in use.

In the embodiment shown in the figures, the machine tool 18 is an electrode nozzle guide for an Electro Discharge Machine (EDM). The operation of the EDM is not necessary for understanding the invention and will not be described in detail, other than to say that in use, an electrode is fed through the machine tool mount 20 into the electrode nozzle guide. The electrode exits the nozzle guide through an aperture 34 in the working end 32 of the nozzle guide. The aperture 34 is also employed as the machine tool location feature 26.

As stated above, the machine tool 18 is mounted on the machine tool assembly mount 20 such that its orientation relative to the machine tool mount 20 can be adjusted. The means for adjustment do not form part of the invention, and will vary depending on the design and nature of the machine tool. In the case of a machine tool 18 (ie the electrode nozzle guide) for an EDM the adjustable mounting take the form of a pivotable coupling which can alter the angle of the nozzle guide relative to the mount 20 by the tightening or loosening of a number of screws which secure the nozzle guide to the mount 20. However, any appropriate means for altering the orientation of the machine tool 18 relative to its mount 20 may be incorporated, provided that working end 32 of the machine tool 18 is adjustable in a direction substantially perpendicular to the calibration axis 30. That is to say the machine tool 18 is mounted such that the working end 32 may be brought onto the calibration axis 30 to cooperatively engage with the positional feature engagement means 24.

The machine tool assembly 16 (shown as a dotted line) is located in the machine tool mount 20 location means 42 to ensure it is aligned as it would be in its parent machine (not shown). The chuck 14 is configured to co-operate with the location features on the machine tool assembly 16 being calibrated. In the embodiment shown, the location means 42 comprise spigots 44 extending from the base of the machine tool assembly 16 into complementary passages 46 (shown as a dotted line in FIG. 1) in the chuck 14. A single dowel 48 also extends from the base of the machine tool assembly 16 to locate in a hole 50 (not shown) provided in the chuck 14, thus ensuring the machine tool assembly 16 can be mounted on the chuck 14 in one orientation only, with the working end 32 of the machine tool 18 pointing towards the headstock 22 substantially along the calibration axis 30. A lever 52 which operates a lock for engagement with the spigots 44 in the passages 46 is provided on the chuck 14.

The positional feature engagement means 24 carried on the calibration headstock 22 is mounted such that it is moveable relative the chuck 20 along the common base 28. In the embodiment presented, the positional calibration means 12 comprising the headstock 22 is fitted with rollers 38 carried on rails 40 fixed to the base 28 which permit the positional calibration means 12 to move towards and away from the machine tool assembly chuck 14 along the machine tool calibration axis 30. The rails 40 prevent any displacement of the calibration headstock 22 other than along the calibration axis 30. That is to say displacement in any direction perpendicular to the calibration axis 30 is prevented. Likewise, twist or rotation of the positional calibration means 12 relative to the calibration axis 30 is prevented by the rails. A brake 54 is provided on the positional calibration means 12 to lock the positional calibration means 12, and hence the headstock 22, relative to the base 28 as required. In this embodiment the brake 52 is provided as a bolt carried in a threaded passageway in the positional calibration means 12. The bolt extends through the passageway and frictionally engages with the base 28 to lock the positional calibration means 12, and hence the headstock 22, in a desired position.

The positional feature engagement means 24 is provided on one end of a location member 60 carried by the calibration headstock 22. The location member 60 is located in a through passage 62 in the calibration headstock 22. A location member locking clamp 64 extends through the wall of the headstock 22 to engage with a clamping surface 66 provided on the location member 60. As shown in FIG. 4, the clamping surface 66 is provided as a recess in the outer surface of the location member 60. The recess ensures that any distortion of the surface of the recess due to engagement with the clamp 64 is kept below the circular surface of the location member 60 so that the extraction of the location member 60 from the passage in the headstock 22 is not impeded. A blind passage, or recess 70 is provided at one end of the location member 60. This may receive (i.e. cooperatively engage with) a positional feature engagement means 24, as described below with reference to FIG. 5. Alternatively, the blind passage or recess 70 may be used as a positional feature engagement means 24. That is to say, the recess 70 is configured to receive (i.e. cooperatively engage with) the machine tool location feature 26. A flange 72 is formed on the member 60 to locate the recess 70 at a predetermined distance from the surface of the headstock 22 from which the location member 60 extends. A shank 74 extends from the flange 72 in a direction away from the recessed end of the location member 60. The shank 74 is used for handling the location member 60, and in particular, for the removal of the location member from the headstock 22.

In FIG. 5, a positional feature engagement means 24 is shown which takes the form of a pin like member 80 configured to fit inside the recess 70 of the machine tool location member 60. The positional feature engagement means 24, formed as a cylindrical shaft 82, extends from a spigot 84. The spigot 84 is configured to locate accurately in the recess 70. The shaft 82 is configured to locate in (ie cooperatively engage with) the machine tool location feature 26 (ie the nozzle guide aperture 34, shown with the working end 32 of the nozzle guide in a dotted line). The pin like member 80 is sized to suit the machine tool location feature 26 with a tolerance applicable to the accuracy of the calibration.

There is a close fit between the positional feature engagement means 24 and the machine tool location feature 26,34. The clearance between the positional feature engagement means 24 and the machine tool location feature 26,34 is such that that they can slid relative to one another, and so that the machine tool location feature 26,34 is located by the positional feature engagement means 24 to within a predetermined and acceptable tolerance. The acceptable tolerance is dependent upon the accuracy required by the machine tool 18 in use in a given application.

In use a machine tool assembly 16 is mounted on the chuck 14 and the positional calibration means 12 is slid along the rails 40 towards to the working end 32 of the machine tool 18. Any mis-alignment between the positional feature engagement means 24 and the machine tool location feature 26 can be seen with the naked eye. The machine tool 18 is then adjusted on the machine tool assembly mount 20 such that the working end 32 of the machine tool 18 is brought into alignment with the positional feature engagement means 24 on the calibration axis 30. That is to say, the working end 32 of the machine tool is adjusted in a substantially perpendicular direction to the calibration axis 30. Alignment of the machine tool 18 with the calibration axis 30, and hence calibration, is complete when the positional feature 24 on the calibration headstock 22 may be positively (ie cooperatively) engaged with the machine tool location feature 26,34 without distortion or bending of the machine tool 18 or positional feature engagement means 24.

Alternatively, adjustable mounting of the machine tool 18 may be slackened off so that the machine tool 18 is free to pivot about its attachment with the machine tool mount 20. The location feature 26 on the machine tool 18 is slid over the positional feature engagement means 24 on the calibration headstock 22, thereby aligning the working end 32 with the calibration axis 30. The adjustable mounting of the machine tool 18 is then tightened such that when the headstock 22 and positional feature engagement means 24 are withdrawn from the machine tool 18, the working end 32 of machine tool 18 is aligned with the calibration axis 30.

Hence when the machine tool 18 is adjusted on the machine tool mount 20 relative to the positional calibration means 12, cooperative engagement of the positional feature engagement means 24 and the machine tool location feature 26,34 without distortion or bending of the machine tool 18 or positional feature engagement means 24 indicates the machine tool 18 is aligned along the machine tool calibration axis 30.

The location of the positional feature engagement means 24, and hence the axis 30, defines the required position of the working end 32 of the machine tool 18 relative to the machine tool assembly mount 20, and corresponds to the required position of the working end 32 relative to a chuck on the parent machine (not shown) to which the machine tool 18 will be mounted in use. Thus when the machine tool assembly 16 is removed from the calibration apparatus 10 and mounted on the parent machine (not shown), the working end 32 of the machine tool will be in the correct position relative to the machine tool assembly chuck on the parent machine. This ensures that working end of the machine tool 18 is guided to the desired location on a workpiece during a machining operation.

In the embodiments shown the positional feature engagement means 24 and the machine tool location feature 26,34 are cylindrical. However, they may have any complementary cross-section, such as polygonal, oval or an irregular shape. An oval or irregular cross-section the machine tool 18 would be of particular use if the machine tool must be aligned with a specific angular position relative to the calibration axis 30. In this embodiment, the machine tool 18 is angularly adjustable on the machine tool mount 20. That is to say, machine tool 18 may be rotatable about the calibration axis 30 in addition to being pivotably adjustable relative to the mount 20.

The present invention provides an easily operated device which accurately aligns a machine tool 18 relative to its location means 42, and obviates the need for a complex measurement process, and the associated measurement equipment and personnel according to the prior art.

The invention has been described with reference to single electrode tooling. However, with minor modifications it could also be employed for calibration of a multi electrode nozzle guide with the provision of multiple positional feature engagement means 24 aligned to define their respective calibration axes.

The invention has been described with reference to a nozzle guide for an EDM. The invention may also be employed to calibration an electrode nozzle guide for an electric arc welding device which employs an electrode.

1. Calibration apparatus comprising a positional calibration means, and a machine tool assembly chuck configured to, in use, locate a machine tool assembly comprising a machine tool configured to be adjustably mounted on a machine tool mount, the positional calibration means and chuck mounted on a common base relative to one another,
wherein the positional calibration means comprises a calibration headstock provided with a positional feature engagement means for cooperative engagement with a machine tool location feature provided on the machine tool,
such that when the machine tool is adjusted on the machine tool mount relative to the positional calibration means, cooperative engagement of the positional feature engagement means and the machine tool location feature indicates the machine tool is aligned along a predetermined machine tool calibration axis.

2. Calibration apparatus as claimed claim 1 wherein the chuck and positional calibration means are moveable relative to one another along the machine tool calibration axis.

3. Calibration apparatus as claimed claim 1 wherein the calibration headstock is carried on rails fixed to the base, such that the positional calibration means can move relative to the chuck along the machine tool calibration axis.

4. Calibration apparatus as claimed in claim 1 wherein the positional feature engagement means is provided on one end of a location member carried by the calibration headstock.

5. Calibration apparatus as claimed in claim 4 wherein the location member is located in a passage in the calibration headstock.

6. Calibration apparatus as claimed in claim 4 wherein the calibration headstock is provided with a location member locking clamp.

7. Calibration apparatus as claimed in claim 6 wherein the location member has a recessed clamping surface for engagement with the locking clamp.

8. Calibration apparatus as claimed in claim 1 wherein the positional feature engagement means is a pin like member configured to fit inside the machine tool location feature.

9. Calibration apparatus as claimed in claim 1 wherein the positional feature engagement means is a recess configured to receive the machine tool location feature.

10. Calibration apparatus as claimed in claim 1 wherein the machine tool is an electrode nozzle guide with the machine tool location feature provided as an aperture for the passage therethrough of an electrode.

11. Calibration apparatus as claimed in claim 10 wherein the electrode nozzle guide is for an electro discharge machine drilling device.

12. Calibration apparatus as claimed in claim 10 wherein the electrode nozzle guide is for a welding device.

13. Method of calibrating a machine tool assembly using a calibration apparatus as claimed in claim 1, wherein a machine tool assembly is mounted on the chuck, and the machine tool is adjusted in a substantially perpendicular direction to the calibration axis so that the positional feature engagement means on the calibration headstock may be cooperatively engaged with the machine tool location feature, thereby aligning the machine tool with the calibration axis.
